(19) United States
(12) Patent Application Publication
(10) Pub. No.: US 2015/0223108 A1
(43) Pub. Date: Aug. 6, 2015

(54) Throttling Cell Notification

(71) Applicant: Robert Skog, Hasselby (SE)

(72) Inventor: Robert Skog, Hasselby (SE)

(73) Assignee: Telefonaktiebolaget L M Ericsson (publ), Stockholm (SE)

(21) Appl. No.: 14/419,326

(22) PCT Filed: Aug. 17, 2012
(86) PCT No.: PCT/SE2012/050881

§ 371 Date: Feb. 3, 2015

(51) Int. Cl. H04W 28/02; H04W 24/10

(52) U.S. Cl. CPC H04W 28/0289; H04W 28/0278; H04W 28/0284; H04W 24/10

(57) ABSTRACT

A network node (240) communicating cell congestion information to a mobile communication device (210) after receiving a request for content from the mobile communication device, wherein the network node compares an identity of the mobile communication device with stored mobile communication device identities, and notifies the mobile communication device of cell congestion, if the mobile communication device identity matches a stored mobile communication device identity.

### TECHNICAL FIELD

The present invention relates generally to telecommunications networks and, more particularly to, methods and apparatus for communicating cell congestion information to a mobile communication device.

### BACKGROUND

A mobile connection can experience a large variation in the radio conditions. The radio conditions in this context refer to the available bandwidth to a user device or connection. Bandwidth reduction for a particular connection can result from an increase in traffic from such factors as users streaming video clips (including gaming) or movies for example. Bandwidth reduction affects the user experience or quality of service (QoS).

One method for mitigating the reduced QoS is the use of HTTP (hypertext transfer protocol) adaptive bit streaming. Video data is encoded at different bit rates and segmented into multi-second parts. A user's bandwidth and CPU capacity are detected in real time. Streaming takes place according to the available resources. Initially, a lower (or the lowest) bit rate video segment is streamed to the client or user. If the user download speed for a segment is greater than the streaming bit rate, a higher bit rate segment is requested by the user. If the download speed for a segment is lower than the bit rate, a lower bit rate segment is requested by the user.

Another method is the use of a proxy to perform a bit rate throttling by which the number of requests processed (or, responded to) by a server may be limited due to network congestion resulting from an increase in user requests, etc. Bit rate throttling may be implemented in radio cells where the number of users and their corresponding requests cause network congestion. That is, bit rate throttling may be implemented in specific cells in order for the users to share the cell capacity as opposed to a few users utilizing a disproportionate share of cell capacity.

As is well known, a feature of a mobile device is to facilitate user movement (i.e. not stationary) in a geographic area served by a plurality of non-overlapping cells of a mobile communication network while providing maintaining communication access. During this movement between cells, a mobile user can enter a crowded radio cell utilizing bit rate throttling—the user may have previously been located within another cell that is not crowded (and not utilizing bit rate throttling). Due to bit rate throttling in the crowded cell, the quality of the services, such as video that the user is viewing will no longer be presented in a manner that is satisfactory to the user. The user may experience freezing images, buffer re-loads, etc. This is not a good end-user experience since he/she may be unclear as to why the service will not work for this “cell” in the previous manner.

Referring to FIG. 1, a cellular communication network 100 can include a plurality of cells (A, - - - , G). A user using mobile communication device UE₀ (UE at time 0) can be viewing a video clip from a data source while the user is within cell B. That is, the user's connection to the data source is facilitated by cellular communication infrastructure assigned to cell B. As the user moves to (or, within) cell A, the communication between the user using mobile communication device UE₁ (UE at time 1) and the data source is facilitated by cell A. Cell B may not be congested and bit rate throttling is not utilized within this cell (i.e. cell B). Cell A, on the other hand, may be congested and bit rate throttling is utilized within this cell (i.e. cell A). As a result, the user experiences is degraded due to bit rate throttling in cell A that results in the afore-mentioned freezing images and constant buffering re-loading, etc.

A need exists, therefore, for systems, methods and apparatus which can provide network and radio cell information to a user.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with an exemplary embodiment, a method for communicating cell congestion information to a mobile communication device is disclosed. The method comprises the steps of: receiving a request for content from the mobile communication device; comparing an identity of the mobile communication device with stored mobile communication device identities; and notifying the mobile communication device of cell congestion if the mobile communication device identity matches a stored mobile communication device identity.

In accordance with another exemplary embodiment, a system for providing cell congestion notification to a mobile communication device is disclosed. The system comprises: a monitor node connected to a radio network and being configured to monitor the radio network to identify congested cells within the radio network and to identify mobile communication devices associated with the congested cells; and a proxy node connected to the monitor node and to the radio network, the proxy node being configured to store identities of the mobile communication devices associated with the congested cells, receive a request for content from a mobile communication device, compare an identity of the requesting mobile communication device with the stored mobile communication device identities and provide a notification of cell congestion if the identity of the requesting mobile communication device matches one of the stored identities.

In accordance with a further exemplary embodiment, a network node is disclosed. The network node comprises: a communication interface for receiving identities of mobile communication devices in congested cells and requests for content from a mobile communication device and for transmitting a notification to the requesting mobile communication device, a memory for storing the received identities of mobile communication devices and a processor for determining if a content request originated from a congested cell by comparing an identity of the requesting mobile communication device with the stored identities and for generating the notification.

In accordance with yet another embodiment, a computer program is disclosed. The computer program comprises computer readable program modules which when run on a network node causes the network node to: receive a request for content from a mobile communication device, compare an identity of the mobile communication device with stored mobile communication device identities and notify the mobile communication device of cell congestion if the mobile communication device identity matches a stored mobile communication device identity.

### BRIEF DESCRIPTION OF THE DRAWINGS

The objects and advantages of the invention will be understood by reading the following detailed description in conjunction with the drawings in which:

FIG. 1 illustrates a communication network;

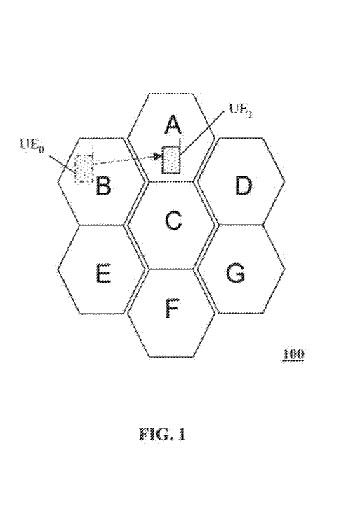

FIG. 2 illustrates a system in accordance with exemplary embodiments;

FIG. 3 illustrates a method in accordance with an exemplary embodiment;

FIG. 4 illustrates a method in accordance with an alternative exemplary embodiment; and

FIG. 5 illustrates a node in accordance with exemplary embodiments.

### DETAILED DESCRIPTION

The various features of the invention will now be described with reference to the figures, in which like parts are identified with the same reference characters or numerals.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors).

Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

According to exemplary embodiments, users (of a mobile communication device) are provided with notification of cells implementing bit rate throttling if (the users are) requesting access to streaming data such as video. In one embodiment, a user may be within a congested cell that implements bit rate throttling when the request for data is initiated. In other embodiments, the user may be in a cell that is not congested at the initiation of the data request (and data receipt) but subsequently moves into a cell that is congested and implements bit rate throttling. The notification in the latter case may be provided upon the user entering the congested cell.

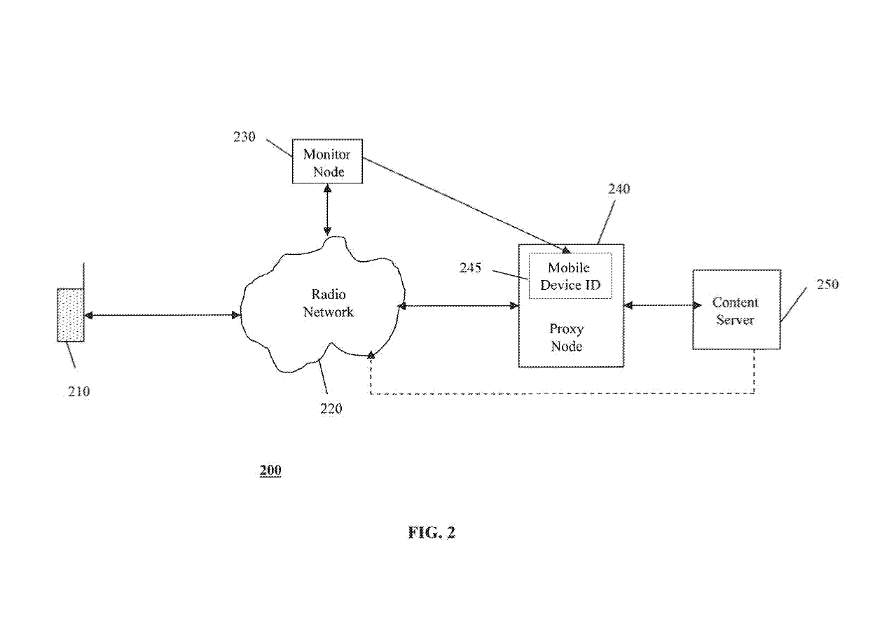

A system in accordance with exemplary embodiments is illustrated in FIG. 2. System 200 includes a proxy node 240 (or, proxy server) intermediate the radio network 220 and content server 250. A plurality of mobile communication devices 210 may access data from content server 250 via radio network 220 and proxy node 240.

System 200 also includes monitor node 230 for monitoring radio network 220. Monitor node 230 identifies cells within radio network 220 that are congested and where data communication can be subjected to bit rate throttling. Monitor node 230 can further identify mobile communication devices 210 within these identified (congested) cells. A mobile communication device can be identified by its Mobile Station International Subscriber Directory Number (MSISDN) or International Mobile Subscriber Identity (IMSI). The identities of these mobile communication devices is provided (and updated) to the proxy node 240. Proxy node 240 can include a storage medium such as memory 245 for storing a list of these identities (referred to as mobile device ID in FIG. 2).

A mobile communication device 210 may request content (such as video content for example) from server 250, e.g. in an HTTP-request. Proxy node 240 receives this request (via radio network 220). Proxy node 240 may compare the MSISDN or IMSI of the requesting device to the mobile device identity list 245 (i.e. stored identities). The requested content is also evaluated to determine if it is of a type (such as a video for example) that is subjected to throttling.

If the identity (MSISDN or IMSI) of the mobile communication device requesting content is not on list 245, then the request is forwarded to content server 250. The requested content may then be provided by content server 250 to requesting mobile communication device 210 (via proxy node 240 and radio network 220 or via radio network 220).

If the MSISDN or IMSI (of the requesting mobile communication device) is on mobile device identity list 245, proxy node 240 notifies requesting mobile communication device 210 that the cell is too crowded or congested to facilitate adequate quality in the provision of the requested service. This notification may be provided in the form of a web page of a mobile browser or via a short message service (SMS). The notification may also indicate that high capacity data transfer (such as video) within the congested cell is subject to bit rate throttling. The content request may not be processed further or it may be placed in a queue.

In some embodiments, requests for certain content may be forwarded to server 250 even if the mobile communication device identity is in the list. This content may not include videos or gaming for example.

In some embodiments, the user may be located in a non-congested cell when making a request for video. The video is received and presented to the user. As the user continues to view the video, he or she may move to a congested cell. Upon entering the congested cell (or when a mobile communication device moves from one cell to another cell), proxy node 240 compares the mobile communication device identity in the manner described above and provides the congested cell notification.

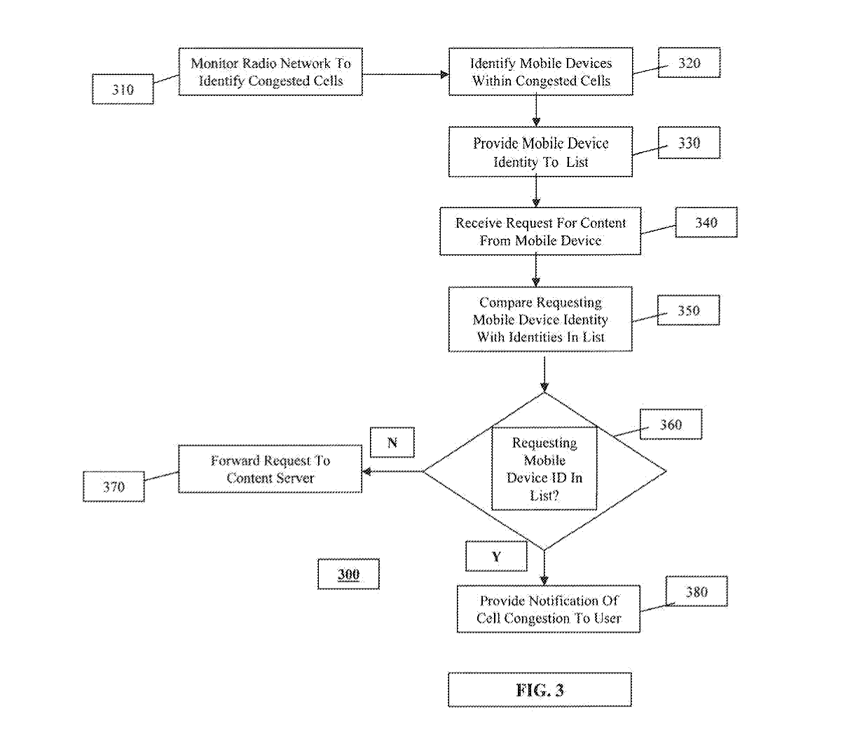

A method in accordance with an exemplary embodiment is illustrated in FIG. 3. A monitor node monitors a radio network to identify congested cells at 310. The congested cells can be implementing bit rate throttling for example. Mobile devices within these congested cells are identified at 320. The mobile devices within the congested cells can be identified by their respective MSISDN or IMSI for example. The identity of the mobile devices is stored in a (mobile communication device identifier) list at 330.

A user can request content or data (from a content server for example) via a mobile communication device, and the request is received, e.g. by a proxy node, at 340. The requesting mobile communication device identity (MSISDN or IMSI) is compared (by a proxy node for example) with mobile communication device identity list at 350. The comparison can include determining if the requesting mobile device identification is on the list at 360. If the mobile communication device identity does not match the identities stored in the list, the request is forwarded to content server at 370. If the mobile communication device identity matches the identities in the list, a notification is provided to the user informing the user of a congested cell implementing bit rate throttling at 380.

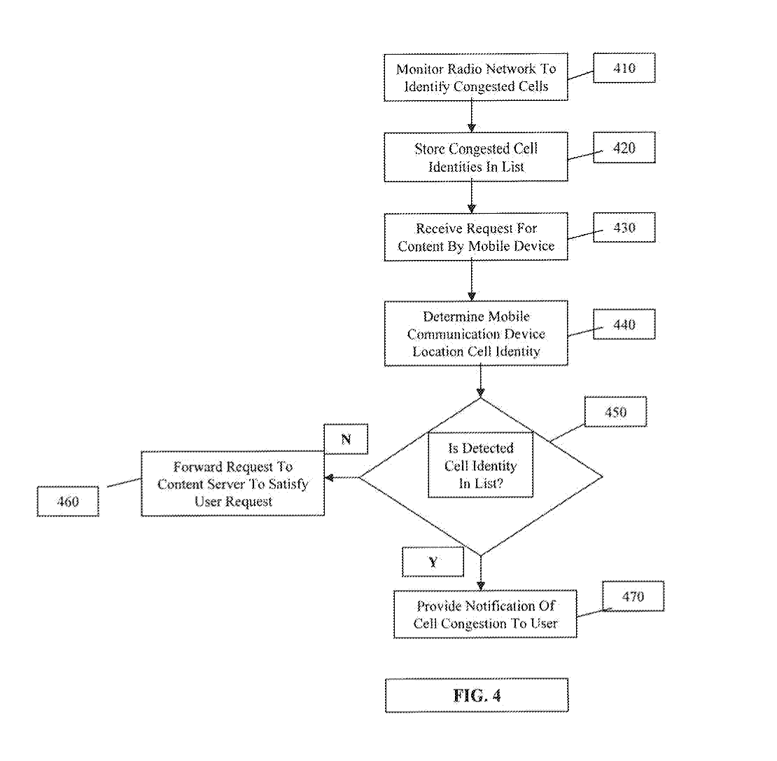

A method in accordance with another exemplary embodiment is illustrated in FIG. 4. A monitor node monitors a radio network to identify congested cells implementing, e.g. bit rate throttling at 410. The identity of the congested cells implementing bit rate throttling is stored in a cell list at 420. A mobile communication device can request content or data from a content server, and the request is received, e.g. by a proxy node, at 430. The identity of the cell within which the requesting mobile communication device is located is determined by a proxy node at 440.

The cell identity is compared to cell identities in the list at 450. If the cell identity does not match any of the cell identities in the list, the request is forwarded to content server at 460. If the cell identity matches a cell identity in the list, a notification is provided to the user that informs the user of a congested cell implementing, e.g. bit rate throttling at 470.

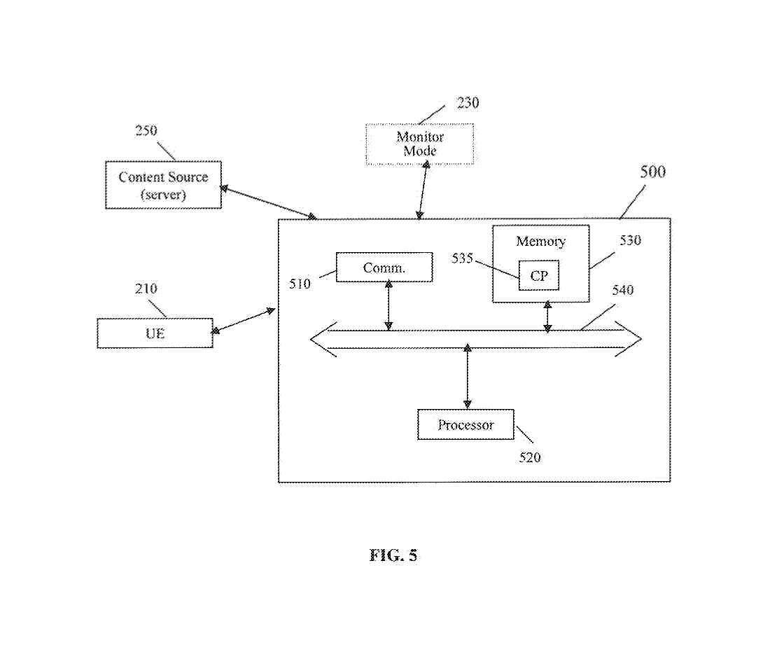

A node (such as proxy node 240 of FIG. 2) in accordance with exemplary embodiments is illustrated in FIG. 5. Node 500 may be located on a network such as a radio network, a public network, a private network or a combination thereof. Node 500 may include a communication interface 510, a processor 520 and computer readable medium 530 in the form of a memory. The communication interface, the processor and the computer readable medium may all may be interconnected via bus 540.

Node 500 may communicate with a monitor node 230, a (user) mobile communication device 210 and a content server 250 via the communication interface 510. Communication interface 510 may transmit to and/or receive from data from these devices. Processor 520 may be a plurality of processors. Node 500 may receive mobile communication device identification information from a monitor mode 230 (as described in FIG. 2). The received information can be stored within memory 530 (i.e. mobile device identification list). Node 500 can receive user requests (via the user mobile communication device) for content (available) from a content source such as the content server.

Processor 520 determines the identity of the mobile communication device communicating with node 500 (requesting content for example). Processor 520 compares the mobile device identification with the communication device identities stored in the list. If the (requesting) mobile communication device identifier is not on the list, processor 520 submits the user request (via 510) to the content server. If the mobile communication device identifier is on the list, processor 520 generates a notification of a congested cell utilizing, e.g. bit rate throttling and communicates this notification (via 510) to the requesting mobile communication device.

In order for processor 520 to be able to perform the steps illustrated in FIGS. 3 and 4, memory 530 comprises a computer program (CP) 535 with computer program modules which when run by the (one or more) processors 520 causes node 500 to perform all or some of the steps illustrated in FIGS. 3 and 4.

An advantage realized by exemplary embodiments as described is that the user of a mobile communication device can be informed about when or why a service (like video) is not accessible for viewing or reasons for quality degradation.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

1-21. (canceled)

22. A method for communicating cell congestion information to a mobile communication device, the method comprising:
receiving a request for content from the mobile communication device;
comparing an identity of the mobile communication device with stored mobile communication device identities;
notifying the mobile communication device of cell congestion if the mobile communication device identity matches a stored mobile communication device identity.

23. The method of claim 22, further comprising:
monitoring a radio network to identify congested cells implementing bit rate throttling;
identifying mobile communication devices within the congested cells;
storing identities of the mobile communication devices within the congested cells in a throttle list.

24. The method of claim 22, further comprising identifying the mobile communication device by a mobile station international subscriber directory number (MSIDN) associated with the mobile communication device.

25. The method of claim 22, further comprising identifying the mobile communication device by an international mobile subscriber identity (IMSI) associated with the mobile communication device.

26. The method of claim 22, further comprising providing the notification to the mobile communication device via a web page.

27. The method of claim 22, further comprising providing the notification to the mobile communication device via a short message service (SMS).

28. The method of claim 22, further comprising communicating the request for content to a content server if the requesting mobile communication device identity does not match a stored mobile communication device identity.

29. The method of claim 28, further comprising providing the requested content by the content server to the mobile communication device.

30. The method of claim 29, further comprising providing the requested content via a proxy node.

31. The method of claim 29, further comprising providing the requested content via a radio network.

32. A system for providing cell congestion notification to a mobile communication device, the system comprising:
one or more processing circuits configured to function as a monitor node, the monitor node connected to a radio network and configured to:
monitor the radio network to identify congested cells within the radio network;
identify mobile communication devices associated with the congested cells;
one or more other processing circuits configured to function as a proxy node, the proxy node connected to the monitor node and to the radio network, the proxy node configured to:
store identities of the mobile communication devices associated with the congested cells;
receive a request for content from a mobile communication device,
compare an identity of the requesting mobile communication device with the stored mobile communication device identities;
provide a notification of cell congestion if the identity of the requesting mobile communication device matches one of the stored identities.

33. The system of claim 32, wherein the proxy node provides the notification to the mobile communication device via one of:
a web page on a mobile browser;
a short message service.

34. The system of claim 32, further comprising a content server having content stored therein, the content corresponding to a content requested by the mobile communication device.

35. The system of claim 34, wherein the proxy node is operatively intermediate the mobile communication device and the content server.

36. The system of claim 35, wherein the content server is configured to receive a request for content from a mobile communication device via the proxy node, when the requesting mobile communication device is located in a non-congested cell.

37. A network node, comprising:
a communication interface configured to:
receive identities of mobile communication devices in congested cells and requests for content from a mobile communication device;
transmit a notification to the requesting mobile communication device;
memory configured to store the received identities of mobile communication devices;
a processing circuit configured to:
determine if a content request originated from a congested cell by comparing an identity of the requesting mobile communication device with the stored identities;
generate the notification.

38. The network node of claim 37, wherein the communication interface is further configured to communicate the request for content to a content server if the processor determines that the content request did not originate from a congested cell.

39. The network node of claim 37, wherein the notification is a notification that the requesting mobile communication device is in a congested cell.

40. The network node of claim 39, wherein the processing circuit is further configured to generate a notification that the requested content is not available due to congestion.

41. The network node of claim 37, wherein the communication interface is further configure to transmit the notification to the mobile communication device via one of:
a web page;
a short message service.

42. A computer program product stored in a non-transitory computer readable medium for providing cell congestion notification to a mobile communication device, the computer program product comprising software instructions which, when run on one or more processing circuits of a network node, cause the network node to:
receive a request for content from a mobile communication device;
compare an identity of the mobile communication device with stored mobile communication device identities;
notify the mobile communication device of cell congestion if the mobile communication device identity matches a stored mobile communication device identity.
